(19) United States
(12) Patent Application Publication
(10) Pub. No.: US 2024/0119276 A1
(43) Pub. Date: Apr. 11, 2024

(54) EXPLAINABLE PREDICTION MODELS BASED ON CONCEPTS

(71) Applicant: INTERNATIONAL BUSINESS MACHINES CORPORATION, Armonk, NY (US)

(72) Inventors: MATTIA RIGOTTI, BASEL (CH); IOANA GIURGIU, ZURICH (CH); THOMAS GSCHWIND, ZURICH (CH); CHRISTOPH ADRIAN MIKSOVIC CZASCH, ZURICH (CH); PAOLO SCOTTON, RUESCHLIKON (CH)

(21) Appl. No.: 17/956,857

(22) Filed: Sep. 30, 2022

(51) Int. Cl. G06N 3/08

(52) U.S. Cl. CPC G06N 3/08

(57) ABSTRACT

Generating a neural network model for producing explainable prediction outputs for input data samples is provided. Training dataset of data samples are provided, each having a prediction label indicating a desired prediction output from the model for that sample, and a set of concept vectors are defined comprising a plurality of concept vectors which are associated with respective predefined concepts characterizing information content of the data samples. A set of input vectors are produced from each data sample. A neural network model is trained that includes a cross-attention module for producing a sample embedding for a data sample and a prediction module for producing a prediction output from the sample embedding.

### BACKGROUND

The present invention relates generally to generating neural network models.

Neural network models are used in numerous applications in science and technology. These models process data samples, which comprise information from the application in question, to produce a prediction output for each sample (e.g., to classify each sample based on a set of categories (classes) which are predefined for that application). Neural network models can be trained by exposing the network to a dataset of training data samples from the application of interest in order to optimize the model for a required prediction task. Training is an iterative process in which training samples are repeatedly supplied to the network, and a set of network weights (which are used to weight signals propagated in the network) is progressively updated so as to optimize a loss function for the network. The trained model, with weights optimized via the training process, can then be applied for inference to new (previously unseen) data samples for the application task in question. These models provide powerful prediction tools and are widely used in applications such as computer vision, speech/language processing, medical diagnosis, genetic analysis, and control of technical systems such as autonomous vehicles, among many other technical applications.

In recent years, there has been a significant move towards designing models which are explainable (i.e., interpretable to humans). Ideally, such models should offer explanations for predictions in terms of high-level, human-understandable concepts to allow the reasons for given predictions to be readily understood by human operators.

### SUMMARY

A first aspect of the present invention provides a computer-implemented method for generating a neural network model for producing explainable prediction outputs for input data samples. The method includes providing a training dataset of data samples, each having a prediction label indicating a desired prediction output from the model, and defining a set of concept vectors comprising a plurality of concept vectors which are associated with respective predefined concepts characterizing information content of the data samples. The method further comprises producing a set of input vectors from each data sample, and training a neural network model, comprising a cross-attention module for producing a sample embedding for a data sample and a prediction module for producing a prediction output from the sample embedding, by supplying the set of input vectors for each data sample to the cross-attention module and training a set of weights of a cross-attention mechanism between the set of input vectors and the set of concept vectors in the cross-attention module, to optimize a loss function dependent on difference between the prediction output and the prediction label for each data sample. The sample embedding comprises a matrix of attention weights and a matrix of value vectors, produced from respective concept vectors, via the cross-attention mechanism, and the prediction output comprises a linear transformation of the product of the matrix of attention weights and the matrix of value vectors.

Another aspect of the invention provides a computer program product comprising a computer readable storage medium embodying program instructions, executable by a computing system, to cause the computing system to perform a method for generating an explainable neural network model as described above.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts an example of an environment for the execution of at least some of the computer code involved in performing the inventive methods;

FIG. 2 depicts a flow diagram of a method for neural network model generation, according to embodiments;

FIG. 3 is a schematic representation of a model training architecture, according to embodiments;

FIG. 4 depicts a flow diagram of an inference process with a trained model, according to embodiments;

FIG. 5 is a schematic representation of a model architecture, according to embodiments;

FIG. 6 illustrates a training architecture, according to embodiments;

FIG. 7 through FIG. 9 illustrate results obtained with a model in an image classification application;

FIG. 10 is a schematic illustration of a cross-attention mechanism, according to embodiments; and

FIG. 11 illustrates training of a cross-attention mechanism, according to embodiments.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as neural network model code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

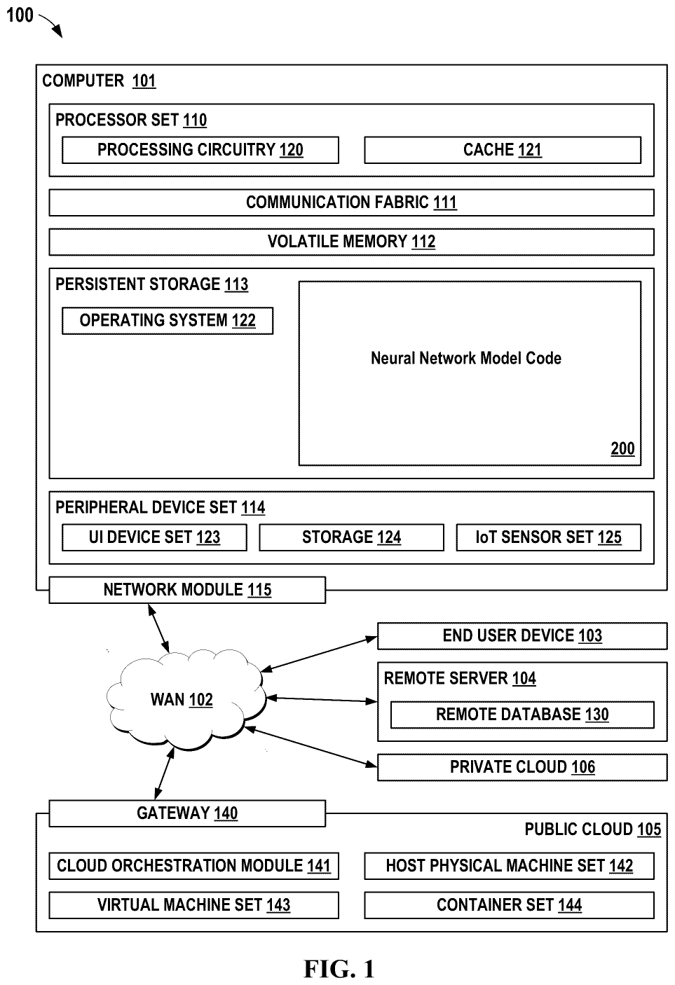

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

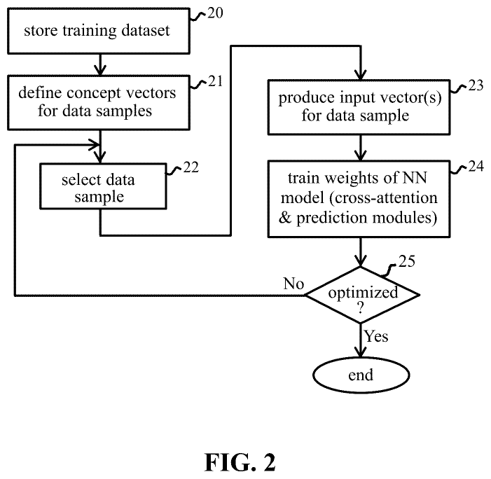

FIG. 2 depicts a method for model generation according to embodiments of the present disclosure. The method can be implemented by a computing system, such as computer 101 using a training dataset of data samples for an application-specific prediction task. For example, the code for implementing some or all of the method may be found in neural network model code 200. Such a task typically involves assigning a data sample to one of a predetermined set of classes (classification) or assigning a value to the data sample on some predefined scale (regression). In step 20 of FIG. 2, the training dataset is stored (e.g., in persistent storage 113). In general, however, the training dataset may be provided locally, or may be provided remotely and accessed by the system via a network (e.g., WAN 102). Each data sample in the training dataset has an associated prediction label which indicates a desired prediction output from the model for that sample.

In step 21, a set of concept vectors is defined by the system. This set comprises a plurality of concept vectors which are associated with respective predefined concepts characterizing information content of data samples in the training dataset. These concepts are therefore specific to the application domain, and can be defined as high-level, human-understandable concepts which will provide a comprehensible basis for predictions made by the model. As an illustrative example, if the prediction task is to identify bird species in images of birds, concepts may be defined for features such as wing color, shape of beak, breast pattern, leg color and so on, which characterize visual features of different birds. Concepts can be similarly defined for any application domain to relate to aspects of the information content of data samples which are relevant for a given prediction task. In some embodiments, the concepts may be user-defined for a prediction task. For other embodiments, concepts may be inferred from domain data based on unsupervised learning techniques. One or a combination of such automatically-generated concepts and user-defined concepts may be employed as desired. A concept vector is defined in step 21 for each such concept predefined for the prediction task. (Some embodiments may also define additional concept vectors as described further below). The overall number of concept vectors will thus vary for different applications, though an image classification application, for instance, might accommodate several hundred concepts. The dimension of these concept vectors (i.e. the number of elements in each vector) can be defined as appropriate for the domain in question. In the bird classification application, for instance, this dimension can be selected so as to adequately accommodate the number of possible categories within concepts such as wing color, beak shape, etc., based on the largest number of categories for any concept. The elements of these concept vectors are free parameters of the training architecture and can be set arbitrarily (e.g., initialized at random) for the model training operation described below.

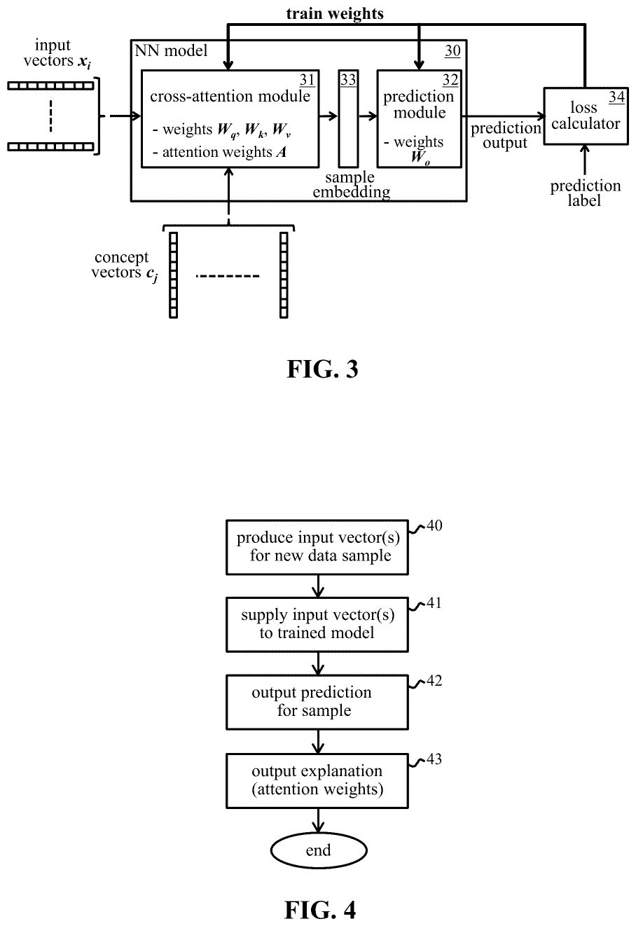

In step 22 of FIG. 2, the system selects a data sample from the training dataset. In step 23, the system processes the data sample to produce a set of input vectors representing that sample. This set of input vectors (which may, in general, comprise one or more input vectors) can be produced in various ways, typically by tokenizing the sample via an embedding process as described below. In step 24, the system uses the set of input vectors, and the prediction label for the sample, to train weights of a neural network (NN) model. FIG. 3 shows basic structure of this model in the training architecture. The NN model 30 comprises a cross-attention module 31 and a prediction module 32. The set of input vectors (denoted here by xᵢ, i=1 to P, P≥1) is supplied to the cross-attention module 31 which also receives the concept vectors (denoted here by cⱼ, j=1 to C) defined in step 21. The cross-attention module 31 includes a set of weights, denoted here by weights matrices W_{q}, Wₖ, and Wᵥ, of a query-key-value cross-attention mechanism in this module. As explained in more detail below, this cross-attention mechanism applies cross-attention between the set of input vectors xᵢ and the set of concept vectors cⱼ to calculate a matrix of attention weights, denoted here by A, of dimensions P by C for the input sample. The cross-attention module 31 then outputs a sample embedding, indicated schematically at 33, to the prediction module 32. This sample embedding 33 comprises the matrix A of attention weights and a matrix (denoted herein by V) of value vectors which are produced from respective concept vectors via the cross-attention mechanism as explained in more detail below.

The prediction module 32, which includes a further set of weights denoted here by matrix Wₒ, processes the sample embedding 33 via the weights Wₒ to produce a predication output for the current sample. The sample embedding 33 may be represented by the two matrices A and V, or by some function of these matrices, but the model 30 is designed such that the resulting prediction output comprises a linear transformation of the product AV of these matrices.

The prediction output is typically indicative of a probability distribution over a predetermined range of possible prediction outputs for data samples. In a classification application, for example, the prediction output can indicate a probability distribution over a plurality of classes defined for classification of data samples. This prediction output is supplied, along with the prediction label for the current sample, to a loss calculator 34 which evaluates a loss function to calculate the network error (loss) for the current sample. This loss function is dependent (at least) on the difference between the prediction output and the prediction label for the data sample. In the training process, indicated schematically by the bold arrows in FIG. 3, the weights W_{q}, Wₖ, Wᵥ of the cross-attention module 31 are incrementally updated to reduce the network loss, here along with the weights Wₒ of prediction module 32. Weight updates can be calculated via a well-known backpropagation process in which the network error is backpropagated through the network to compute errors in different layers of the network, and the weights are updated in each layer to move towards an optimal weight-set.

In decision step 25 of FIG. 2, the system decides if the loss function has been optimized for the application task. (Optimization, or convergence, can be defined in various known ways, e.g. as the point at which the network loss cannot be reduced any further, and the particular convergence condition is orthogonal to the operation described). If not, operation reverts to step 22 and the training process continues for the next sample. Operation thus iterates until the model has been optimized at step 25, whereupon training is complete. The resulting trained model 30, with weights optimized via the training process, is stored (e.g., in persistent storage 113) and can be applied for inference as described below.

By applying cross-attention between the input vectors and the concept vectors in model 30, the model is trained to make predictions based on human-understandable concepts predefined for the prediction task. During the training process, the model learns embeddings of these concepts which reflect how particular concepts (e.g. beak color=red, wing color=blue, etc.,) appearing in samples are correlated with the correct prediction results defined by the prediction labels. The model thus learns to detect which concepts are present in samples and make predictions on this basis. The distribution of concepts identified for an input sample is reflected in the attention weights A which therefore provide an “explanation” for the model's decision. Moreover, because the prediction output comprises a linear transformation of the product AV of the attention weights A and the value vectors V, the model output is guaranteed to be faithful to the distribution of attention over the concepts. In other words, the explanation (attention weights A) for a prediction faithfully represents the model's operation, and there is no need for post-hoc explanation of results. This faithfulness of operation offers truly interpretable models and is critical for many applications, such as medical diagnosis for instance, where human operators need to be sure of the reasons for a given prediction result. With models generated by methods embodying this invention, model outputs are explainable in terms of readily-understandable concepts and the explanation is guaranteed to faithfully reflect the model's operation.

After training model 30 as described above, the model can be applied for inference to new (i.e., unseen during training) data samples. Steps of the inference process are depicted in FIG. 4. The code for implementing some or all of the inference process may be found in neural network model code 200. In step 40, a set of input vectors xᵢ, i=1 to P, is produced from a new input data sample in the same manner as for training samples in step 23 of FIG. 2. In step 41, the resulting set of input vectors is supplied to model 30 with fixed weights (W_{q}, Wₖ, Wᵥ and Wₒ) as optimized during training. The prediction output for the sample is obtained at step 42. The attention weights A calculated for the sample in cross-attention module 31 can be output in step 43, if desired, to provide an explanation for the model's decision.

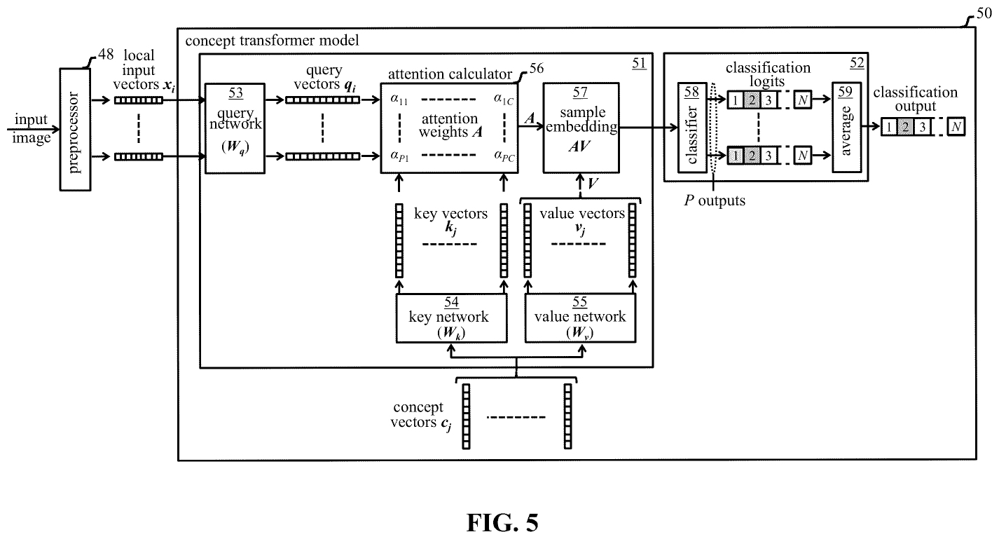

Operation of the cross-attention mechanism is explained in more detail below for an exemplary embodiment. Here, the FIG. 2 method generates an image classification model 50 whose architecture is shown in FIG. 5. An input sample, in the form of a digital image, is supplied to a preprocessor 48 which generates a plurality P of input vectors xᵢ via a tokenization process. The preprocessor 48 may use generally-known techniques to tokenize an input image. The goal is to decompose the image into different portions, or “patches”, (e.g., a 16-by-16 pixel grid), and to generate embedding vectors corresponding to respective patches. By way of example here, the image can be processed through a ResNet50 neural network without the final average pool and classifier layers. The result is then decomposed into patches and each patch is flattened into a vector. The resulting vectors are then processed via a self-attention function (transformer) to produce the tokens (embedding vectors). The embedding process here preserves correspondence between the embedding vectors and respective portions (patches) of the data sample. The resulting embeddings are thus associated with respective, localized portions of the input sample and constitute a set of “local input vectors” xᵢ for that sample.

The image classification model (“concept transformer” model) 50 of this embodiment comprises a cross-attention module 51 and a classification module 52. The cross-attention module 51 receives the local input vectors xᵢ which can be represented by a matrix X∈ [symbol] ^{P×e}^{ₚ}, where P is the number of image patches (and hence local input vectors), and eₚ is the number of patch embedding dimensions. The cross-attention module also receives the set of concept vectors cⱼ which represent the concept embeddings and can be represented by a matrix C∈ [symbol] ^{C×e}^{_{c}}, where C is the number of concepts and e_{c} is the number of concept embedding dimensions. The elements of this matrix C are randomly initialized for the training operation.

Cross-attention module 51 includes a query network 53, with weights W_{q}, which applies a linear transformation F_{q}(X) to the matrix of local input vectors. This transformation, e.g. F_{q}(X)=XW_{q}, produces a matrix Q of query vectors qᵢ for the QKV (query-key-value) cross-attention mechanism, where Q∈ [symbol] ^{P×d} with d being the number of QKV embedding dimensions. The cross-attention module 51 also includes a key network 54 with weights Wₖ, and a value network 55 with weights Wᵥ. Key network 54 applies a linear transformation Fₖ(C) to the matrix of concept vectors, e.g. Fₖ(C)=CWₖ, to produce a matrix K of key vectors kⱼ for the QKV mechanism, where K∈ [symbol] ^{C×d}. Similarly, value network 55 applies a linear transformation Fᵥ(C) to the concept vectors, e.g. Fᵥ(C)=CWᵥ, to produce a matrix V of value vectors vⱼ for the QKV mechanism, where V∈ [symbol] ^{C×d}.

The query vectors qᵢ and key vectors kⱼ are supplied to an attention calculator 56 which calculates the matrix of attention weights A∈ [symbol] ^{P×C} for the input sample. Each attention weight αᵢⱼ in this matrix is calculated as:

$${α}_{ij} = softmax ( \frac{1}{\sqrt{d}} {q}_{i} \cdot {k}_{j} )$$

where “⋅” denotes dot product, and “softmax” here indicates that the dot product results

$$( \frac{1}{\sqrt{d}} {q}_{i} \cdot {k}_{j} )$$

for all i,j are normalized via a softmax function. The resulting attention weights A are supplied to a sample embedding calculator 57 which generates the sample embedding as the product AV of the matrix of attention weights and the matrix of value vectors.

The sample embedding AV is supplied to a classifier network 58, e.g. a linear network with weights Wₒ, of classification module 52. The classifier network 58 applies a linear transformation F_{y}(AV) to the sample embedding. This linear transformation, e.g. F_{y}(AV)=AVWₒ, with Wₒ∈ [symbol] ^{d×N}, projects the sample embedding onto the (unnormalized) N classification logits (log probabilities) over the N output classes. As indicated schematically in the figure, the classifier network 58 thus outputs P vectors of N classification logits, one for each input vector (and hence image patch). Each of the P classification vectors provides a prediction result for a respective patch of the input image, in the form of a probability distribution over the output classes (indicated schematically by shading in the figure). The patch prediction results are aggregated in module 59, here by averaging corresponding classification logits over the P classification vectors. The N logits lₙ of the final classification output for the input sample are thus given by:

$${l}_{n} = \frac{1}{P} {\sum }_{i = 1}^{P} {( A V {W}_{o} )}_{i n} , with n = 1 to N .$$

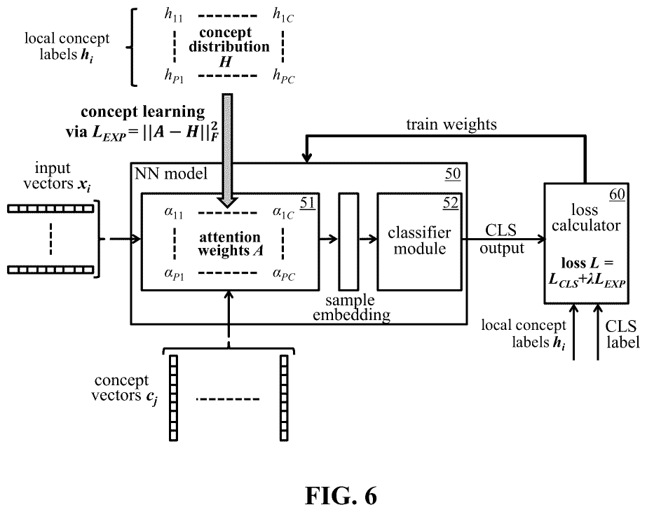

The schematic in FIG. 6 illustrates a training architecture for model 50, where components corresponding to those of FIG. 5 are indicated by like reference numerals. In this architecture, the attention weights A are supervised during training based on concept labels for the data samples. In particular, a set of concept labels is defined for each data sample, where this set of concept labels indicates those predefined concepts which characterize information content of that sample. The loss function for the training operation then further depends on difference between a desired distribution of attention (as indicated by the set of concept labels) and the matrix of attention weights for each data sample. For the “patch-based” operation of model 50, the set of concept labels for a sample comprises a plurality of local concept labels associated with respective local input vectors. Each local concept label indicates those concepts (if any) which characterize information content of the portion of the data sample (here image patch) corresponding to the local input vector associated with that concept label.

The loss calculator 60 in the architecture of FIG. 6 receives both the classification (CLS) label for the input image and the local concept labels, denoted here by hᵢ, for the image patches corresponding to respective input vectors xᵢ. For example, each concept label hᵢ may be a binary vector, of dimension C, in which the value of each element hᵢⱼ indicates presence (1) or absence (0) of concept j in patch i. The loss function L here is given by L=L_{CLS}+λL_{EXP}, where: L_{CLS} is the classification loss term (i.e., difference between the model output and the CLS label for the sample); L_{EXP} is an “explanation loss” term; and λ>0 is a constant which can be set as deemed appropriate for the application, e.g. λ=2. The explanation loss L_{EXP} is defined here as L_{EXP}=∥A−H∥_{F}², where H is the desired concept distribution (indicated by the matrix of concept labels hᵢ), and ∥*∥_{F} denotes the Frobenius norm. As illustrated schematically in the figure, the effect of the explanation loss term L_{EXP} is to guide the attention mechanism to attend to concepts which are present in the input sample.

The training architecture of FIG. 6 ensures that, while model 50 is learning concepts via the cross-attention mechanism, it learns the “right” (or relevant) concepts by focusing attention on them specifically. This concept learning mechanism results in higher quality embeddings and ensures plausibility of the model output (where plausibility is a measure of how convincing the explanation for the model's operation is to humans).

It will be seen that model 50 uses cross-attention to generate classification log probabilities as additive contributions from predefined concepts. The model enforces a linear relation between the weighted value vectors and the classification logits, which itself follows from computing the model outputs via the linear projection F_{y}(AV), and aggregating patch contributions by averaging. The model thus provides concept-based interpretability by design. The model output faithfully reflects the distribution of attention over the concepts, and attention weights A provide a true and plausible explanation for the classification output in terms of these concepts. Moreover, the “patch-based” approach, with local input vectors corresponding to respective portions of the sample, allows accommodation of localized concepts, i.e. concepts present in particular portions of the input sample. Concept localization is then reflected in the matrix of attention weights and, due to the linear relation described above, localization of concept explanations is preserved in the model output.

It will be appreciated that different preprocessing architectures may be employed for preprocessor 48 depending on the domain and complexity of the training dataset. In general, model 50 can be used as a drop-in replacement for the prediction head of an arbitrary deep learning architecture (e.g. by replacing a fully-connected classification layer at the output of an existing NN model with the concept transformer model of FIG. 5). The resulting model can then be trained end-to-end. In some embodiments, input samples may be used directly as input vectors, without embedding. Also, while a single attention head is described above for simplicity, multi-head attention can be employed in other embodiments as well as additional processing stages, such as batch normalization, as will be readily apparent to those skilled in the art.

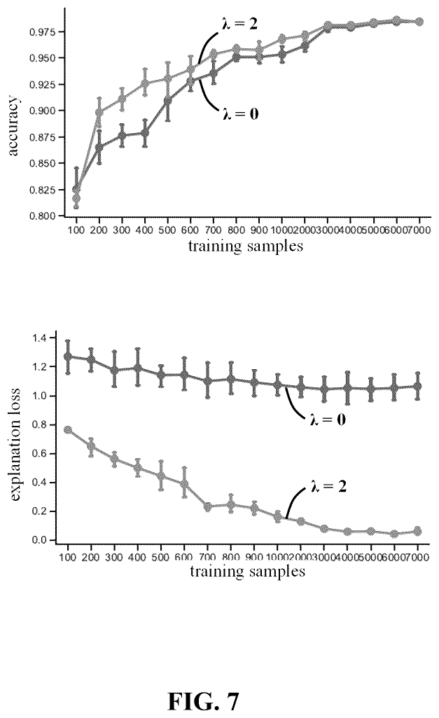

While a patch-based approach with local concept labels is described above, in general one or more input vectors xi may be generated for a sample. For example, a single, “global” input vector may represent the whole input sample, and an associated global concept vector may indicate those concepts which characterize information content of the data sample as a whole. This global approach may be more appropriate for datasets where concepts are largely characteristic of entire data samples. An example of such as dataset is the Binary MNIST dataset which comprises a dataset of images of hand-written digits. The concept transformer model 50 of FIG. 5 was trained for the task of classifying the digit, ranging from 0 to 9, in MNIST input samples as either even or odd. This task can exploit the fact that the identity of each digit is known, and this can be used that as an explanation (i.e. the concept label) for the binary classification prediction. For instance, a ‘7’ should be classified as ‘odd’, and a plausible explanation to support this prediction is that “it is ‘odd’ because it is a ‘7’”. In FIG. 7, the upper plot shows how the model accuracy progressed with number of training samples (from 100 to 7000), with both λ=0 and λ=2 in the loss function. The model achieved 99% accuracy with both values of λ for the highest number of training samples. However, for fewer training samples (e.g. 100 to 500), a significant performance boost is evident with λ=2. The lower plot in FIG. 7 shows variation of the explanation loss, L_{EXP}=∥A−H∥_{F}², with number of training samples for λ=0 and λ=2. The drop in explanation loss demonstrates that the model is able to identify correct explanations for predictions. It can also be seen that λ=2 results in a marked improvement in the explanation loss, and hence corresponding improvement in model plausibility.

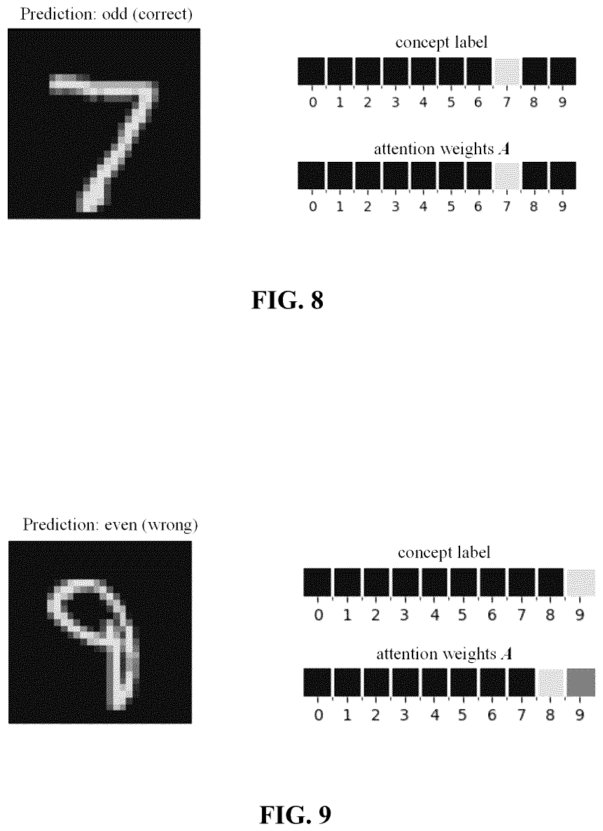

FIGS. 8 and 9 show how concepts that are being learned by the model can be used to understand predictions and diagnose possible classification mistakes. FIG. 8 shows a test sample from the MNIST dataset, a ‘7’ whose correct binary label is ‘odd’, which is a prediction that should be supported by the correct ground-truth explanation ‘7’ (i.e., the sample is odd because it is a 7). The model provided the correct prediction in this case, and looking at the concept attention weights (with higher weight value from 0 to 1 being indicated by lighter shading here), we can see that indeed this prediction is supported by the correct explanation. FIG. 9, on the other hand, shows an example of a test sample which was misclassified by the model. The sample, a ‘9’, should be classified as an odd digit, but is misclassified as even. Looking at the attention weights, however, the reason for the incorrect prediction can be traced back to the fact that the model strongly associated the sample to the ‘8’ concept. That is, the model predicted the sample to be ‘even’ because it “thought” that it was an ‘8’. Notice also that the correct concept ‘9’ is being attended to by the architecture, but the wrong concept ‘8’ received, in this case, a higher attention score. Interestingly, visually inspecting the sample, it is arguable that it indeed resembles an 8.

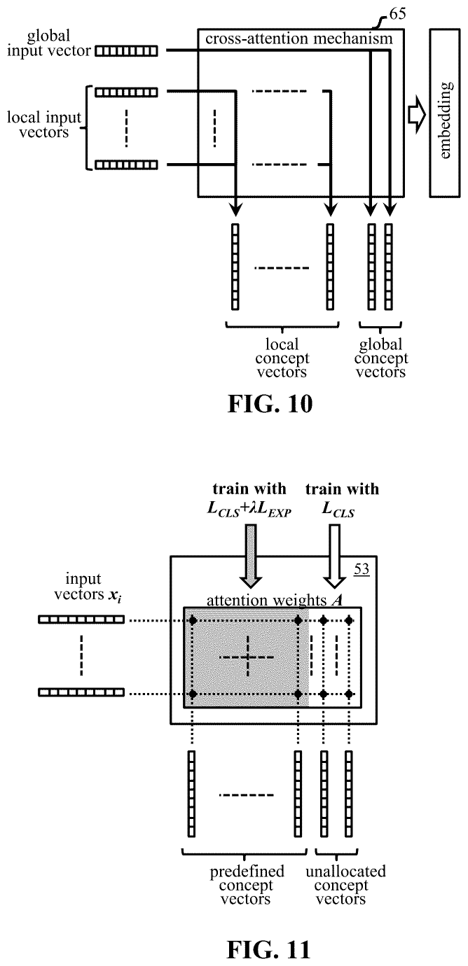

Embodiments may use either one, or both, of the local and global approaches as appropriate for a given application domain. In particular, some applications may accommodate both local and global concepts. An illustrative example here is bird classification based on the CUB-200-2011 dataset. This dataset contains 11788 images of birds, classified in 200 species. Each image is annotated with a given number of concepts (e.g., shape of the beak, color of the back, etc.) explaining the classification. In this dataset there are 312 concepts in total. Some of these are localized concepts (beak color, eye color, etc.,) and others are global concepts (bird size, overall shape, etc.). For applications like this, the set of input vectors for a data sample can include a global input vector, corresponding to the whole data sample, as well as a plurality of local input vectors corresponding to respective portions of the sample. The set of concept labels can then comprise both a global concept label, associated with the global input vector, and a plurality of local concept labels associated with respective local input vectors. In the image classification model of FIG. 5, for example, a global input vector can be generated by aggregating (e.g., averaging) the patch embedding vectors xᵢ. The cross-attention mechanism can then be tailored to accommodate both local and global concepts as illustrated schematically in FIG. 10. Here, the concept vectors are divided into local concept vectors, associated with local concepts characterizing information content of portions of the data samples, and global concept vectors associated with global concepts characterizing information content of data samples as a whole. As indicated schematically by the arrows in cross-attention mechanism 65 here, cross-attention is applied between each local input vector and each local concept vector, and between each global input vector and each global concept vector. The cross-attention mechanism 65 thus only queries the relevant (local or global) concepts for each of the input vectors.

Further embodiments may accommodate a number of “unallocated” concept vectors, which are not associated with a predefined concept, in the concept vector set for a model. This allows the model to discover the presence of concepts which were not predefined for the prediction task. The FIG. 11 schematic illustrates the training of attention weights in cross-attention module 53 in this case. As indicated by the shaded area in the figure, the attention weights corresponding to predefined concept vectors are trained as described with reference to FIG. 6, using the explanation loss L_{EXP} in the loss function. However, the attention weights corresponding to unallocated concept vectors are trained based on classification loss L_{CLS} only. Post-analysis of the attention weights corresponding to unallocated concepts in relation to input samples for which these concepts were active (i.e. high-value attention weights) can then indicate additional concepts useful for the domain.

It will be seen that the embodiments described allow generation of NN prediction models which are truly explainable in terms of readily-understandable concepts, which are faithful by design and are inherently plausible through supervision of the attention weights. Moreover, the training operation described has been shown to enhance prediction performance, providing more accurate models and improved results for real-life inference applications. The improvement in model accuracy is particularly apparent with smaller training sets. Effective models can be trained more quickly, with fewer training samples, reducing compute resources required for the (computationally-intensive) training operation.

It will be appreciated that many changes and modifications can be made to the exemplary embodiments described. For example, while the above explanation has focused on image classification as a particularly intuitive example, embodiments of the invention can be applied to various data modalities and numerous technical applications. As well as digital image (including digital video) data, input data samples may comprise, for instance, audio data (e.g., speech/voice data for a voice recognition application); text data (e.g. for a predictive text application or an automated question answering system); measurement data for physical system (e.g. sensor output data in an application for controlling a machine, computer network or autonomous vehicle); or medical data for patients. Applications can also be envisaged for data samples comprising sequential data, e.g. time series data such as streaming data generated by some technical system. An illustrative example here might be credit card transaction data from a financial network, with model 50 offering an explanation for identification of particular transactions as fraudulent.

Where data samples comprise measurement data for a physical system, the physical system may be any technological system and the task may be to determine a state of the system for controlling system operation, e.g. selecting an action to be performed in the system. Applications can also be envisaged in which the physical system is a biological entity such as person, where the task may be to verify identity of a person based on biometric data, or determine the emotional state of person based on expression, gesture, posture, voice, etc., measurements from digital image/audio data. In other applications, the physical system may be a natural system such as a weather system, geological system, etc., with the task being weather prediction, seismic event prediction, and so on.

Where data samples comprise medical data for patients, the prediction task may be to provide some type of medical evaluation for a patient. Medical data may comprise data obtained from tissue specimens, different modality images/scans and/or other measurements or results of tests on patients. The medical evaluation task may, for example, comprise diagnosis, prognosis, treatment selection/treatment evaluation for particular patients in the field of personalized medicine, and may involve any prediction task such as classification, e.g. disease identification/sub-typing, etc., or regression, e.g., severity grading, longevity prediction, and so on. Numerous other technical applications can be readily envisaged.

Alternatives/modifications described in relation one embodiment may be applied to other embodiments as appropriate. In general, where features are described herein with reference to a method embodying the invention, corresponding features may be provided in a computer program product for implementing such a method.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for generating a neural network model for producing explainable prediction outputs for input data samples, the method comprising:
providing a training dataset of data samples each having a prediction label indicating a desired prediction output from the model;
defining a set of concept vectors comprising a plurality of concept vectors which are associated with respective predefined concepts characterizing information content of the data samples;
producing a set of input vectors from each data sample; and
training a neural network model, comprising a cross-attention module for producing a sample embedding for a data sample and a prediction module for producing a prediction output from the sample embedding, by supplying the set of input vectors for each data sample to the cross-attention module and training a set of weights of a cross-attention mechanism between the set of input vectors and the set of concept vectors in the cross-attention module, to optimize a loss function dependent on difference between the prediction output and the prediction label for each data sample;
wherein the sample embedding comprises a matrix of attention weights and a matrix of value vectors, produced from respective concept vectors, via the cross-attention mechanism, and the prediction output comprises a linear transformation of a product of the matrix of attention weights and the matrix of value vectors.

2. The method of claim 1, wherein:
a set of concept labels is defined for each data sample, the set of concept labels indicating those concepts which characterize information content of that sample; and
the loss function is further dependent on difference between a desired distribution of attention indicated by the set of concept labels and the matrix of attention weights for each data sample.

3. The method of claim 1, further comprising, after generating the neural network model, applying the model for inference to a new data sample by producing a set of input vectors from the new data sample and supplying that set of input vectors to the model to obtain a prediction output for the new data sample.

4. The method of claim 3, further comprising providing, with the prediction output for the new data sample, matrix of attention weights for the new data sample as an explanation of the prediction output.

5. The method of claim 1, wherein the set of input vectors for a data sample comprises a plurality of local input vectors corresponding to respective portions of that data sample.

6. The method of claim 2, wherein:
the set of input vectors for each data sample comprises a plurality of local input vectors corresponding to respective portions of that data sample; and
the set of concept labels comprises a plurality of local concept labels, associated with respective local input vectors, each indicating those concepts which characterize information content of the portion of the data sample corresponding to the local input vector associated with that concept label.

7. The method of claim 1 wherein the set of input vectors for each data sample comprises a global input vector corresponding to the whole data sample.

8. The method of claim 2, wherein:
the set of input vectors for each data sample comprises a global input vector corresponding to the whole data sample; and
the set of concept labels comprises a global concept label, associated with the global input vector, indicating those concepts which characterize information content of the data sample as a whole.

9. The method of claim 2 wherein:
the set of input vectors for each data sample comprises a global input vector corresponding to the whole data sample and a plurality of local input vectors corresponding to respective portions of that data sample;
the set of concept labels includes a plurality of local concept labels, associated with respective local input vectors, each indicating those concepts which characterize information content of the portion of the data sample corresponding to the local input vector associated with that concept label; and
the set of concept labels further comprises a global concept label, associated with the global input vector, indicating those concepts which characterize information content of the data sample as a whole.

10. The method of claim 9 wherein:
the predefined concepts comprise a set of local concepts, characterizing information content of portions of said data samples, and a set of global concepts characterizing information content of data samples as a whole; and
in the cross-attention module, cross-attention is applied between each local input vector and each concept vector associated with a local concept, and between each global input vector and each concept vector associated with a global concept.

11. The method of claim 1 wherein the set of concept vectors further comprises at least one unallocated concept vector which is not associated with a concept.

12. The method of claim 1, wherein producing the set of input vectors from each data sample comprises tokenizing each data sample via an embedding process.

13. The method of claim 5, wherein producing the set of input vectors from each data sample comprises tokenizing each data sample via an embedding process which preserves correspondence between the input vectors and respective portions of the data sample.

14. The method of claim 1, wherein:
the set of input vectors for each data sample comprises a plurality of input vectors;
the prediction module produces, via said linear transformation, a prediction result corresponding to each input vector; and
the prediction output is produced by aggregating the prediction results for the input vectors.

15. The method of claim 1, wherein the prediction output is indicative of a probability distribution over a predetermined range of possible prediction outputs for data samples.

16. The method of claim 1, wherein the prediction module comprises a classification module and said prediction output is indicative of a probability distribution over a predetermined plurality of classes for classification of data samples.

17. The method of claim 1 wherein the data samples comprise one of image data, audio data, measurement data for physical system, text data, sequential data, and medical data for patients.

18. The method of claim 1, wherein the data samples comprise image data and wherein the prediction module comprises a classification module.

19. A computer program product for generating a neural network model for producing explainable prediction outputs for input data samples, the computer program product comprising a computer readable storage medium having program instructions embodied therein, the program instructions being executable by a computing system to cause the computing system to:
define a set of concept vectors comprising a plurality of concept vectors which are associated with respective predefined concepts characterizing information content of data samples in a training dataset of data samples, each data sample having a prediction label indicating a desired prediction output from the model;
produce a set of input vectors from each data sample; and
train a neural network model, comprising a cross-attention module for producing a sample embedding for a data sample and a prediction module for producing a prediction output from the sample embedding, by supplying the set of input vectors for each data sample to the cross-attention module and training a set of weights of a cross-attention mechanism between the set of input vectors and the set of concept vectors in the cross-attention module, to optimize a loss function dependent on difference between the prediction output and the prediction label for each data sample;
wherein the sample embedding comprises a matrix of attention weights and a matrix of value vectors, produced from respective concept vectors, via the cross-attention mechanism, and the prediction output comprises a linear transformation of a product of the matrix of attention weights and the matrix of value vectors.

20. A computer program product as claimed in claim 19 wherein the program instructions are further executable to cause the computing system, after generating the neural network model, to apply the model for inference to a new data sample by producing a set of input vectors from the new data sample and supplying that set of input vectors to the model to obtain a prediction output for the new data sample.
